(19) United States
(12) Patent Application Publication
(10) Pub. No.: US 2017/0109905 A1
(43) Pub. Date: Apr. 20, 2017

(54) GPS Trail Attributes Based on Secondary Data

(71) Applicant: Navico Holding AS, Egersund (NO)

(72) Inventor: Lucas Dale Steward, Broken Arrow, OK (US)

(21) Appl. No.: 14/887,093

(22) Filed: Oct. 19, 2015

(51) Int. Cl. G06T 11/20; G06T 11/60; G06T 11/00; G01S 19/13

(52) U.S. Cl. CPC G06T 11/203; G01S 19/13; G06T 11/60; G06T 11/001

(57) ABSTRACT

Various implementations described herein are directed to a non-transitory computer-readable medium having stored thereon a plurality of computer-executable instructions which, when executed by a computer, cause the computer to perform various actions. The actions may include receiving a plurality of geographical location data over time, receiving secondary data associated with the geographical location data, and rendering an image of the plurality of geographical location data as a trail, wherein a graphical attribute of the trail is variable based on variations in the secondary data.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

GPS trails displayed on a multi-function display can be useful to fishermen, boat pilots and other users of GPS navigation data displays. A device that can use secondary data to improve displayed GPS trails can provide advantages.

### SUMMARY

Described herein are implementations of various technologies for a method of operating a GPS navigation device. In one implementation, a non-transitory computer-readable medium having stored thereon a plurality of computer-executable instructions which, when executed by a computer, cause the computer to perform various actions. The actions may include receiving a plurality of geographical location data over time, receiving secondary data associated with the geographical location data, and rendering an image of the plurality of geographical location data as a trail, wherein a graphical attribute of the trail is variable based on variations in the secondary data.

Described herein are further implementations of various technologies for a method of operating a GPS navigation device. In one implementation, a non-transitory computer-readable medium having stored thereon a plurality of computer-executable instructions which, when executed by a computer, cause the computer to perform various actions. The actions may include receiving a plurality of geographical location data over time, receiving secondary data associated with the geographical location data, determining a range of the secondary data received, assigning the highest value in the range to a first color, and assigning the lowest value in the range to a second color, wherein the second color is different from the first color. The actions may further include rendering an image of the plurality of geographical location data as a trail wherein the color of the trail is rendered in the first color where the associated secondary data is the highest value in the range, and in the second color where the associated secondary data is the lowest value in the range.

Described herein are implementations of various technologies for a method of displaying GPS navigation data on a screen. In one implementation, the method may include receiving a plurality of geographical location data over time, receiving secondary data associated with the geographical location data, determining a range of the secondary data, assigning the highest value in the range to a first color, and assigning the lowest value in the range to a second color, wherein the second color is different from the first color. The method may further include rendering an image of the plurality of geographical location data as a trail wherein the color of the trail is rendered in the first color where the associated secondary data is the highest value in the range, and in the second color where the associated secondary data is the lowest value in the range.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Moreover, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates an image on display on a multi-function display system in accordance with various implementations described herein.

FIG. 2 illustrates an image on display on a multi-function display system in accordance with various implementations described herein.

FIG. 3 illustrates an image on display on a multi-function display system in accordance with various implementations described herein.

FIG. 4 illustrates a block diagram of a multi-function display system in accordance with various implementations described herein.

FIG. 5 illustrates a flow diagram of a method for acquiring, processing, and displaying GPS navigation data and secondary data in accordance with various implementations herein.

FIG. 6 illustrates a flow diagram of a method for acquiring, processing, and displaying GPS navigation data and secondary data in accordance with various implementations herein.

FIG. 7 illustrates a color wheel in accordance with various implementations herein.

FIG. 8 illustrates a flow diagram of a method for acquiring, processing, and displaying GPS navigation data and secondary data in accordance with various implementations herein.

FIG. 9 illustrates a schematic of a marine electronics device in accordance with implementations of various techniques described herein.

### DETAILED DESCRIPTION

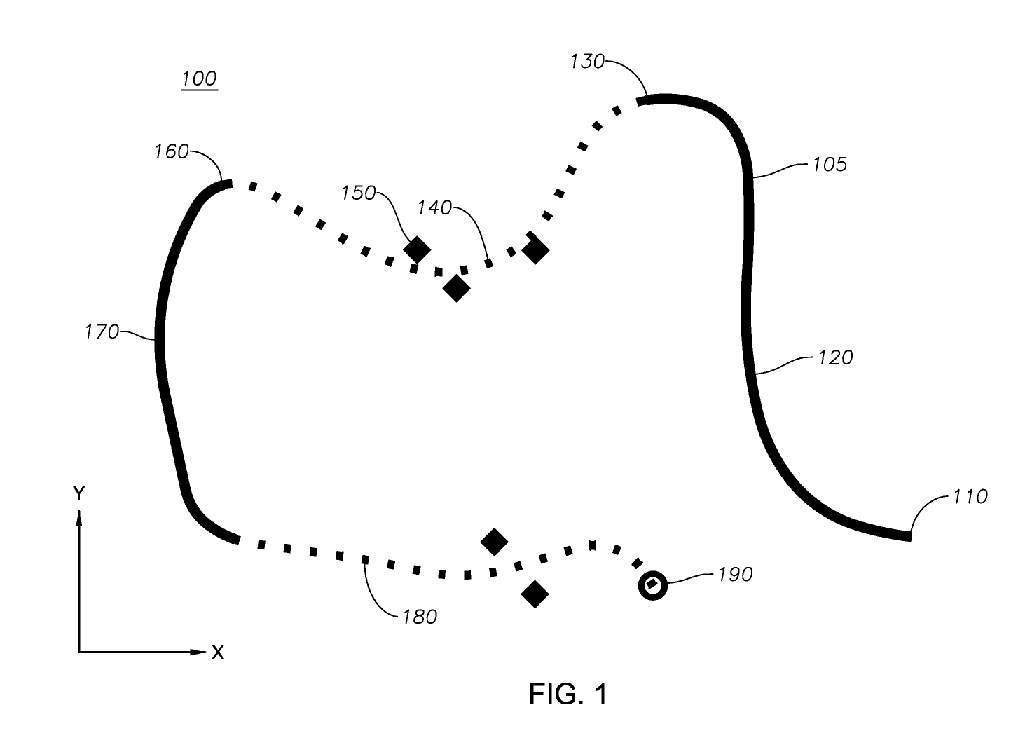

Various implementations of GPS navigation data display described herein will now be described in more detail with reference to FIGS. 1-9.

FIG. 1 illustrates a GPS image 100 that may be displayed by a multi-function display device in accordance with various implementations described herein. The multi-function display device may be associated with a motor vehicle, such as a motorized marine vessel. The multi-function display device may acquire GPS navigation data as well as motor data from the motor vehicle.

The GPS image 100 may include a two-dimensional graphic depicting an aerial view of a trail 105 travelled by the marine vessel. The trail 105 may indicate GPS location data that may be changing over time, indicating movement of the marine vessel. In some implementations, the trail 105 may have a variety of graphical attributes that represent a variety of motor status data. For instance, this attribute may be color, opacity, intensity, pattern, thickness, or any other graphical attribute. For example, segments 120, 170 of the trail may be displayed in one pattern, such as a solid pattern, as illustrated. This pattern may indicate portions of the route or session where motor status data has indicated that the motor is in gear. Segments 130, 160 of the trail 105 indicate where the motor is transitioned to be out of gear, or in neutral. Dotted segments 140, 180 of the trail illustrate where the motor has been continuously in neutral. Such changes in the GPS navigation location data, indicating movement of the marine vessel while the motor is in neutral may indicate where a vehicle has been moving without the assistance of motor drive such as a where a marine vessel has been drifting, or where a land vehicle has been coasting.

The image 100 may show the trail 105 with a starting point 110 that represents the beginning of a session. A session may start when the multi-function display is powered on, upon a manual trigger by a user, or by a preset trigger within the software of the multi-function display device. The image 100 may also include an indication of the current position 190 of the motor vehicle. As data is acquired over time, the trail 105 may increase in length and include additional portions.

The image 100 may be oriented so that the vertical axis (y-axis) indicates north and south directions, and the horizontal axis (x-axis) indicates east and west directions. Alternatively, the image may be oriented so that the axes change as the orientation of the device changes. For example, the device may be equipped with a gyroscope such that if the device is oriented so that it faces east, the vertical axis (y-axis) may transition to display east and west, while the horizontal axis (x-axis) displays north and south.

As discussed, above, the trail 105 may illustrate GPS navigation data along with motor data received over time. The data may be real-time data acquired during a current session, or may be historical data acquired during a previous session. If historical data is being viewed, the current position 190 may or may not align with the trail 105.

The image 100 may further indicate waypoints 150 positioned by a user. Waypoints may indicate locations of hazards or locations of interest, such as where fish are located. In some implementations, the combined visual representation of waypoints 150 with the GPS trail 105 may provide distinct advantages to users.

The image 100 may be overlaid on chart data. Chart data may include map features represented by lines i.e. vectors representing roadways, common routes, geographical features, and other items of interest. Chart data may also include points of interest (POIs).

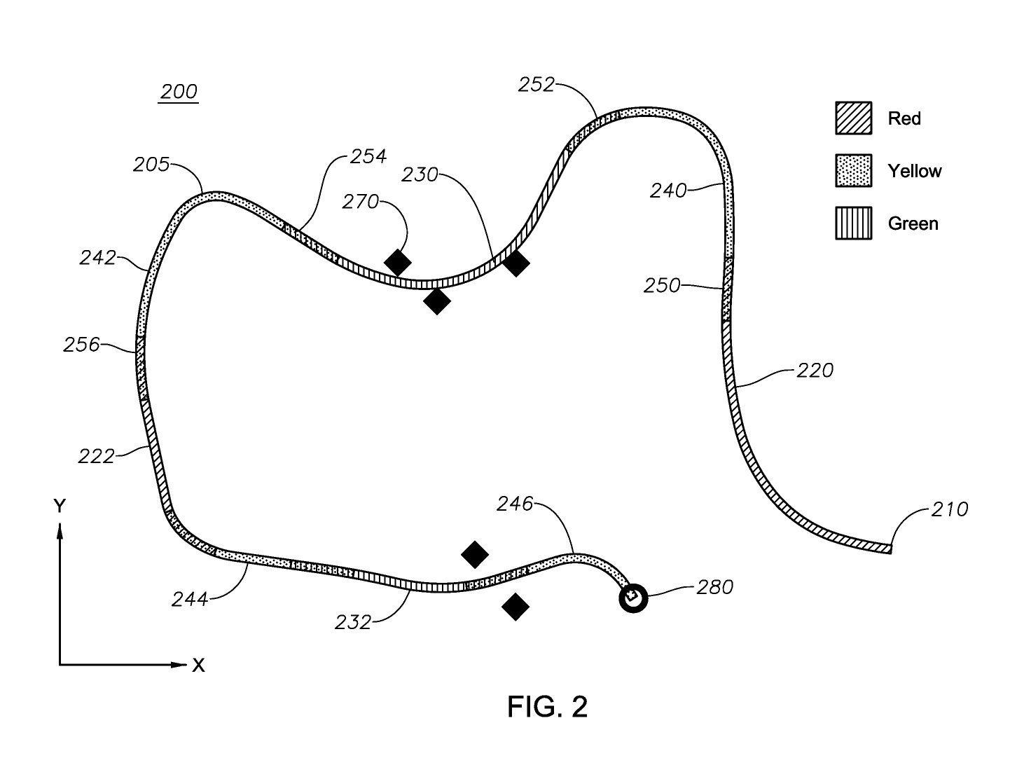

FIG. 2 illustrates a GPS navigation data image 200 that may be displayed by a multi-function display device in accordance with various implementations described herein. As in previously discussed implementations, the multi-function display device may be associated with a motor vehicle, such as a motorized marine vessel. The multi-function display device may acquire GPS navigation data as well as some secondary data of interest. In the case of a land vehicle, the secondary data may include speed, elevation, or any other data of interest. The secondary data may be acquired by the display device itself, the vehicle, or some associated external device. In the case of a marine vessel, the secondary data may include speed, surface water temperature, water depth, wave height, or any other data of interest. This secondary data may also be any data acquired by the display device, the vehicle, or an associated external device.

As in the image 100 FIG. 1, the GPS navigation data image 200 is a two-dimensional graphic depicting an aerial view of a trail 205 travelled by the vehicle. The image 200 illustrates a starting point 210 that represents the location of the vehicle at the beginning of a session and the current position 280 of the vehicle. In some implementations, the trail 205 may be depicted using a variety of graphical attributes to indicate variations in the secondary data. The graphical attribute may be the color of the trail 205. For instance, using various techniques described herein, a user may easily ascertain from a quick visual inspection of the image 200, the relative water depths encountered during the session. As illustrated, where the secondary data of interest is water depth, portions 220, 222 of the trail 205 may be shaded in red, indicating areas of least depth encountered during a session. Portions 230, 232 of the trail 205 may be shaded in green to indicate the greatest depth encountered during the session. Portions 240, 242, 244, 246 of the trail 205 may be shaded in yellow to indicate intermediate depth during the session. Portions 250, 252, 254, 256 that are in between two colors, are shaded in colors along a spectrum ranging from 100% one color to 100% of the other color. For example, the portion at 250, lying in between the red portion 220 and the yellow portion 240, may be shaded in colors ranging from 100% red to 100% yellow. The portion at 252, lying in between the yellow portion 240 and the green portion 230, may be shaded in colors ranging from 100% yellow to 100% green. The portion at 254, lying in between the green portion 230 and the yellow portion 242, may be shaded in a colors ranging from 100% green to 100% yellow. The portion at 256, lying in between the yellow portion 242 and the red portion 222, may be shaded in colors ranging from 100% yellow to 100% red.

The image 200 may further include waypoints 270 positioned by a user, indicating locations of interest. The combined visual representation of waypoints 270 with the GPS trail 205 may provide distinct advantages to users. For example, as illustrated, a user may be able to easily deduce that points of interest have coincided with portions of the trail 230, 232 that are shaded in green. A user may then return to those locations, or look for additional locations having similar conditions.

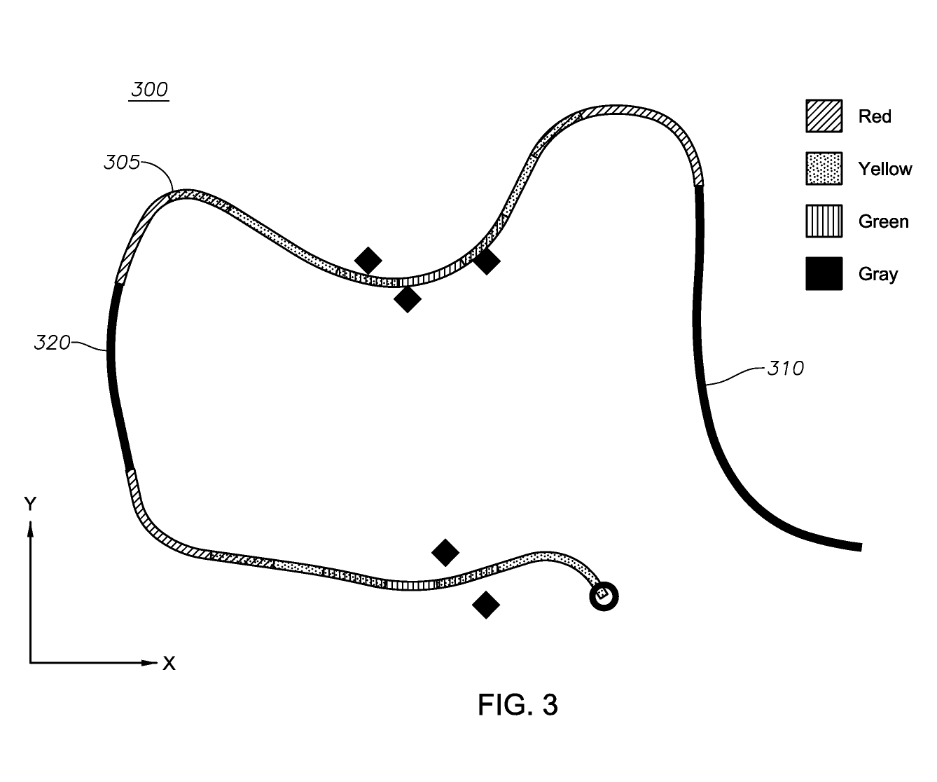

FIG. 3 illustrates a GPS navigation data image 300 that may be displayed by a multi-function display device in accordance with various implementations described herein. As in previously discussed implementations, the multi-function display device may acquire GPS navigation data as well as some secondary data of interest. In some implementations, a user may be provided the option to define a range of secondary data that is of special interest. Upon determination of a range of interest, any portions 310, 320 of the trail having associated secondary data that falls outside the range of interest may be depicted in “grayed out” color. All other portions of the trail where the associated secondary data falls within the range of interest may be shaded in red, green, and yellow. This feature allows users to ignore data not of interest and view additional detail that may be displayed where the GPS data and secondary data fall within the range of interest. For example, the associated secondary data illustrated in FIG. 3 may be temperature data. The user-defined range of interest may be smaller than the range of received temperature data. Therefore, where the temperature data falls outside the range of interest, the trail 305 is gray. Where the temperature data falls within the range of interest, the trail 305 is colored, and more variation of temperatures within the range may be illustrated.

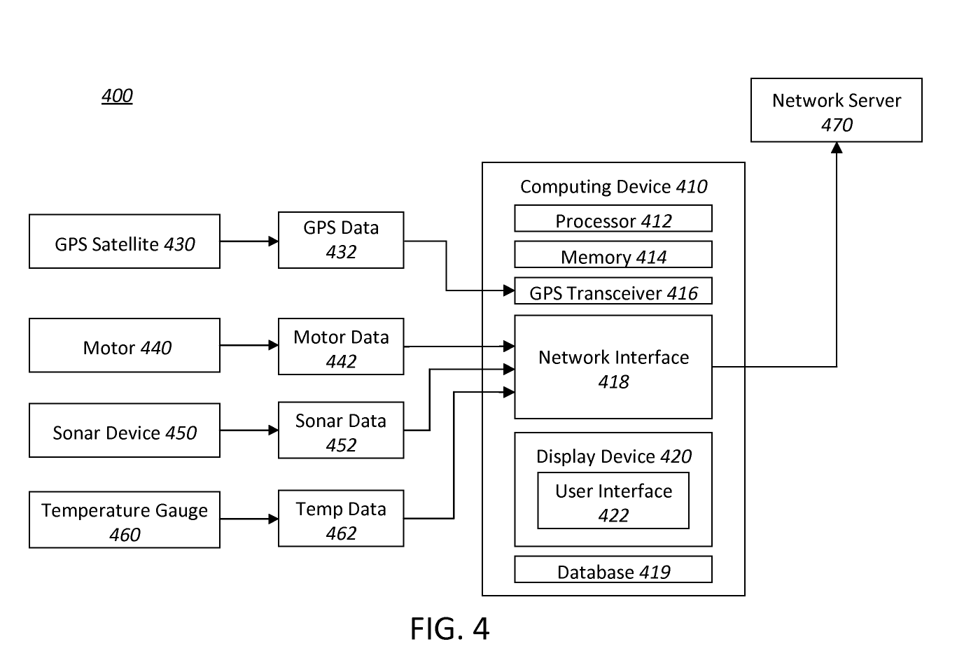

FIG. 4 illustrates a block diagram of a GPS display system 400 in accordance with various implementations described herein. The GPS display system 400 may include a number of different modules or components, each of which may comprise any device or means embodied in either hardware, software, or a combination of hardware and software configured to perform one or more corresponding functions. The GPS display system 400 may include a computing device 410 including a display 420 which may include an integrated user interface touch screen. The computing device 410 may be a marine electronics device, MFD, smart phone, computer, laptop, tablet, etc. The computing device 410 may be configured as a special purpose machine for interfacing with a motor 440, sonar device 450, and/or temperature gauge 460. The computing device 410 may include a GPS transceiver 416 for receiving GPS data 432 from a GPS Satellite 430. In some implementations, altitude data may be derived from GPS data. The computing device 410 may further include a wireless network interface 418 that may receive transmitted secondary data. The computing device 410 receives motor status data 442 from a motor 440 and/or sonar data 452 from a sonar device 450. In some implementations, wave height data and water depth data may be derived from sonar data 452. The network interface 418 may also include a mobile wireless internet interface, which may allow the user of the computing device 410 to access a network server 470 on the internet. Further, the computing device 410 may include various standard elements and/or components, including the at least one processor 412, the memory 414 (e.g., non-transitory computer-readable storage medium), at least one database 419, power, peripherals, and various other computing components that may not be specifically shown in FIG. 4. The memory 414 may include instructions that cause the processor 412 to receive and process the GPS data 432 and secondary data 442, 452, 462. In some implementations, the memory 414 may include instructions that cause the processor 412 to derive secondary data such as speed or altitude from the GPS data 432. In some other implementations, the memory 414 may include instructions that cause the processor 412 to derive wave height or water depth data from sonar data 452. Further, the memory 414 may include instructions that cause the processor 412 to determine trail attributes to be displayed by the computing device 410.

The computing device 410 may include a display device 420 (e.g., a monitor or other computer display) that may be used to provide a user interface 422, including a graphical user interface (GUI). The display 420 may be an incorporated part of the computing device 410. Alternatively, the display 420 may be implemented as a separate component. Further, the user interface 422 may be used to receive one or more preferences from a user of the display device 420 for customizing the GPS trail, including choosing the type of secondary data to be displayed, altering the automatic range mode, or choosing a manual range of special interest to display. The user interface 422 may allow the user to adjust settings and/or configure one or more external devices 440, 450, 460 in real time.

The processor 412 may store, record and/or log the GPS data, secondary data, and trail attributes in one or more databases 419. Further, the computing device 410 may be configured to upload the GPS data 432, motor data 442, sonar data 452, temperature data 462, or data derived from any of the aforementioned data, and/or data log files to a network server 470 via the network interface 418. In some implementations, the computing device 410 may be configured to upload data corresponding to trail attributes to at least one database via a network interface 418. The network server 470 may be a cloud server or other network server.

Various elements and/or components of the system 400 that may be useful for the purpose of implementing the system 400 may be added, included, and/or interchanged, in a manner as described herein. For example, the computing device 410 may have built in functionality and capabilities that may further assist the user. For example, the computing device 410 may have mobile wireless internet access. Mobile wireless internet access may allow a user to access additional secondary data such as weather forecasts, radar maps, tidal information, moon phases, sunrise and sunset calendars and the like.

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. The computing systems may be configured to operate using various radio frequency technologies and implementations, such as sonar, radar, GPS, and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

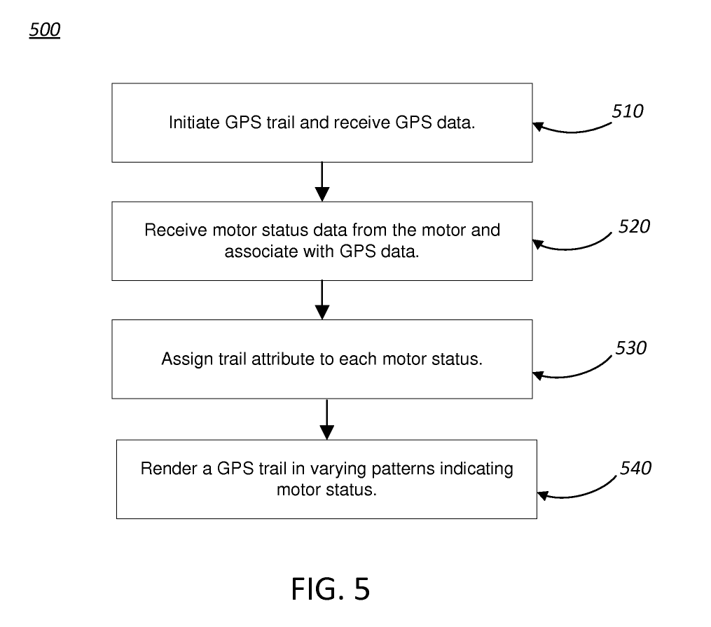

FIG. 5 illustrates a flow diagram of a method 500 for acquiring, processing, and displaying a GPS trail in accordance with various implementations herein. In one implementation, method 500 may be performed by any computing system, including a computing system referenced in FIG. 4, a portable computer system, a smart phone device, a remote server, a marine electronics device, a cloud server and the like. It should be understood that while method 500 indicates a particular order of execution of operations, in some implementations, certain portions of the operations might be executed in a different order, and on different systems. Further, in some implementations, additional operations or steps may be added to the method 500. Likewise, some operations or steps may be omitted. In one implementation, method 500 may be performed by one or more computer applications, where the computer applications may implement one or more of the steps described below.

At block 510, a GPS trail may be initiated and GPS data 432 may be received by a computing device 410. The collection of the GPS data 432 may be caused by the execution of instructions from the memory 414 and received by the processor 412. Alternatively, the collection of GPS data 432 may 410 be triggered by a user via the user interface 422 of the computing device 410. In some implementations the initiation of a GPS trail may be an automatic process triggered by the powering on of the computing device 410. The initiation of the GPS trail may alternatively be manually triggered by a user action, such as the selection of a related view or task on the computing device 410.

At block 520, in one embodiment, motor status data 442 may be received from the motor 440 by the computing device 410 via the network interface 418 of the computing device 410. The motor status data 442 may be associated with contemporaneous GPS data 432 based on a clock, time stamps, or any other synching mechanism. The collection of the motor status data 442 may similarly be caused by the execution of instructions from the memory 414 and received by the processor 412. The collection of motor status data 442 may be triggered by a selection by the user or upon powering on the computing device 410.

At block 530, the computing device processor 412 may assign a contrasting variety of a graphical line attribute to each motor status. The graphical line attributes assigned may be related to line weight, pattern, color, intensity, or any other graphical attribute of a line. For example, as illustrated in FIG. 1, at this step 530, the graphical line attribute may be the pattern of the line. For instance, a solid pattern may indicate that the motor is in gear (i.e., in forward or reverse) status, and a dotted pattern may indicate that the motor is out of gear (i.e., in neutral) status. The type and variety of graphical line attribute may be predetermined, or may be selected or customized by a user.

At block 540, the computing device processor 412 may render an image of the GPS trail including the various graphical line attributes determined at block 530. The portions rendered in each variation may visually show the motor status data with the corresponding GPS data determined at block 520. For example, as illustrated in FIG. 1, a GPS trail 105 is rendered having two portions 120, 170 where the trail 105 is rendered with a solid pattern, indicating that the motor was in gear. The GPS trail 105 additionally has two portions 140, 180 where the trail 105 is rendered in a dotted pattern to indicate that the motor was out of gear.

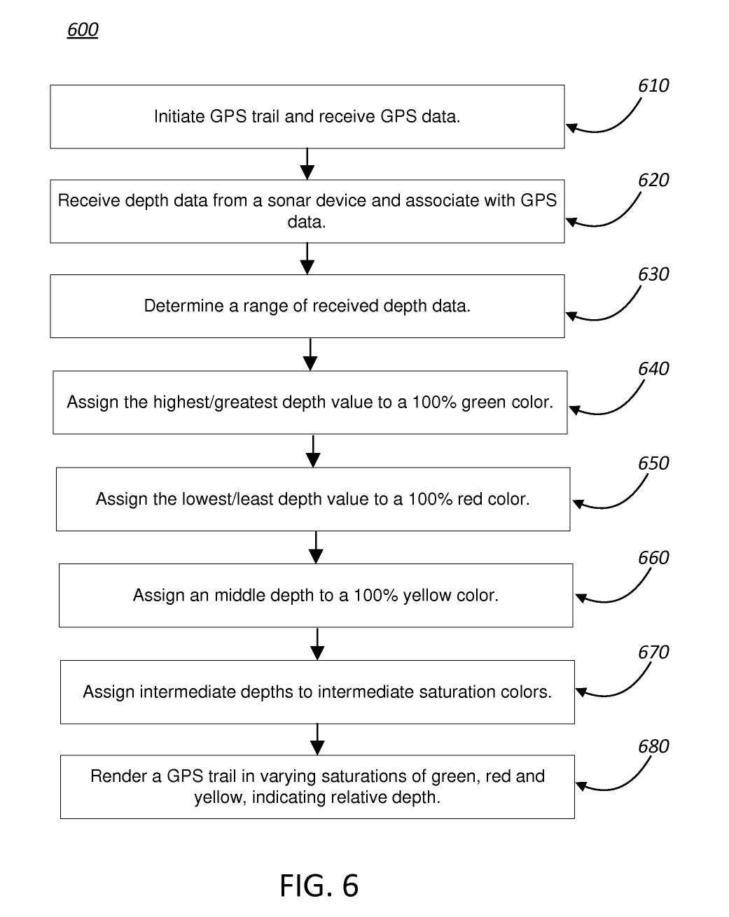

FIG. 6 illustrates a flow diagram of a method 600 for acquiring, processing, and displaying a GPS trail in accordance with various implementations herein. In one implementation, method 600 may be performed by any computing system, including a computing system referenced in FIG. 4, a portable computer system, a smart phone device, a remote server, a marine electronics device, a cloud server and the like. It should be understood that while method 600 indicates a particular order of execution of operations, in some implementations, certain portions of the operations might be executed in a different order, and on different systems. Further, in some implementations, additional operations or steps may be added to the method 600. Likewise, some operations or steps may be omitted. In one implementation, method 600 may be performed by one or more computer applications, where the computer applications may implement one or more of the steps described below.

At block 610, a GPS trail may be initiated and GPS data 432 may be received by a computing device 410. The collection of the GPS data 432 may be caused by the execution of instructions from the memory 414 and received by the processor 412. Alternatively, the collection of GPS data 432 may 410 be triggered by a user via the user interface 422 of the computing device 410. In some implementations the initiation of a GPS trail may be an automatic process triggered by the powering on of the computing device 410. The initiation of the GPS trail may alternatively be manually triggered by a user action, such as the selection of a related view or task on the computing device 410.

At block 620, depth data 442 may be acquired and associated with GPS data 432. The depth data may be derived from sonar data 452 received from a sonar device 450. The depth data may be associated with contemporaneous GPS data 432 based on a clock, time stamps, or any other synching mechanism. The collection of the sonar data 452 may similarly be caused by the execution of instructions from the memory 414 and received by the processor 412. The collection of the sonar data 452 may be triggered by a selection by the user or upon powering on the computing device 410.

At block 630, the computing device processor 412 may determine a depth range of all the depth data acquired at block 620. This depth range may have a highest value and a lowest value.

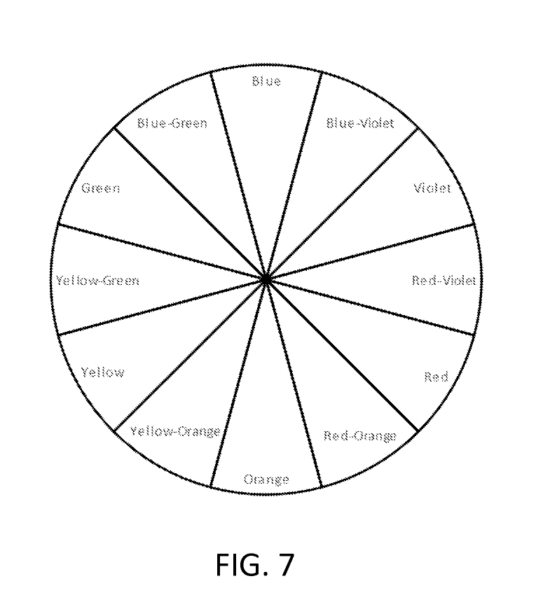

At block 640, the highest value in the range determined at block 630 may be assigned to a variety of a graphical line attribute. The graphical line attribute may be line weight, pattern, hue, intensity, or any other graphical attribute of a line. FIG. 7 shows a color wheel, according to some implementations, where the graphical line attribute is color. The color assigned to the highest value may be a predetermined color from the color wheel, or may be customized by a user. The color wheel may include only primary colors (red, yellow and blue). In some implementations, the color wheel may also include secondary colors (orange, green, and purple) and/or tertiary colors (red-orange, yellow-orange, yellow-green, blue-green, blue-purple, and red-purple), as illustrated in FIG. 7. The color wheel may include additional or fewer colors, and is not limited to a certain number of colors or a specific spectrum of colors. The assigned color for the highest value in the depth range may be green.

At block 650, the lowest value in the depth range determined at block 630 may be a second color that is contrasting to the color assigned at block 640. A contrasting color may be a color having a segment that is non-adjacent on a color wheel showing primary, secondary, and tertiary colors. For instance, the lowest value in the range may be assigned to a hue of red, which lies on the opposite side of the color wheel in FIG. 7, and is therefore a contrasting color to the color assigned at block 640, green. The second color may be predetermined, or may be customized by a user.

At block 660, a middle value may be determined. This middle value may be the mean of the highest and lowest values of the range determined at block 630. The middle value may be assigned a third color that is contrasting to both the first and second colors assigned at blocks 640 and 650, respectively. As in block 650, the contrasting color may be a color that is represented by a non-adjacent segment on a color wheel showing primary, secondary, and tertiary colors. For instance, the middle value in the range may be assigned to a hue of yellow. The third color may be predetermined, or may be customized by a user.

At block 670, intermediate values that are not the highest, lowest, and middle values determined at blocks 640, 650, and 660 may be determined. These intermediate values may be assigned colors that are a combination of two colors. For instance, the highest, middle, and lowest values may be determined to be 45 feet, 25 feet, and 5 feet, respectively. The highest value, 45 feet may be assigned to the color green. The middle value, 25 feet, may be assigned to the color yellow, and the lowest value, 5 feet, may be assigned to the color red. Values in between 45 feet and 25 feet may be assigned a color that is a combination of the two colors assigned to those values (i.e., green and yellow). For example, the values shown in Table 1 may be used to define colors that are a combination of yellow and green and that may be assigned to intermediate depths between 25 feet and 45 feet.

TABLE 1

| | |
|---|---|
| Depth | Color |

| (feet) | % Yellow | % Green |
|---|---|---|
| 25 | 100 | 0 |
| 26 | 95 | 5 |
| 27 | 90 | 10 |
| 28 | 85 | 15 |
| 29 | 80 | 20 |
| 30 | 75 | 25 |
| 31 | 70 | 30 |
| 32 | 65 | 35 |
| 33 | 60 | 40 |
| 34 | 55 | 45 |
| 35 | 50 | 50 |
| 36 | 45 | 55 |
| 37 | 40 | 60 |
| 38 | 35 | 65 |
| 39 | 30 | 70 |
| 40 | 25 | 75 |
| 41 | 20 | 80 |
| 42 | 15 | 85 |
| 43 | 10 | 90 |
| 44 | 5 | 95 |
| 45 | 0 | 100 |

A similar table may be created to determine combination colors to represent intermediate depths lying between the lowest and middle values. As discussed above, those lowest and middle values may be represented by red and yellow, respectively. Thus, intermediate values may be represented by corresponding colors consisting of combinations of red and yellow. Table 1 illustrates assigning colors to depth values in whole number increments, but larger or smaller increments may be used. Further, Table 1 illustrates a linear relationship between the depth and amounts of each color combined, but other mathematical relationships may be used to determine the combination of colors.

At block 680, the computing device processor 412 may render an image of the GPS trail including the various colors determined at blocks 640, 650, 660, and 670. For example, as illustrated in FIG. 2, a GPS trail 205 may be rendered having two portions 220, 222 where the trail 205 is rendered in 100% red, showing that the depth data received were the lowest of the depth data received during the session. The GPS trail 205 is 100% green at 230 and 232, showing that the depth data received at these portions of the trail 205 are the highest depth data received during the session. At portions 240, 242, and 244 the trail 205 is rendered in 100% yellow, indicating that the depth data received at those portions of the session equal the middle value. Portions 250 and 256 in between red and yellow portions are colors that are a combination of red and yellow, as discussed above. Portions 250 and 254 that lie between portions that are 100% green and 100% yellow, respectively, may be rendered in colors that are a combination of green and yellow, as shown in Table 1.

There may be a delay or other mechanism put into place to decrease demand on processing resources or to lower the frequency of rendering of the displayed GPS trail 205. For instance, a new depth range determination made at block 630 may not be used in the rendering at block 680 unless the range depth data passes a certain threshold. The depth data may be processed to ensure that any change in depth is significant or whether it should be ignored. Because depth data may be derived from sonar data, 452, the sonar data 452 may be filtered to reduce interference or noise pollution from other noise sources.

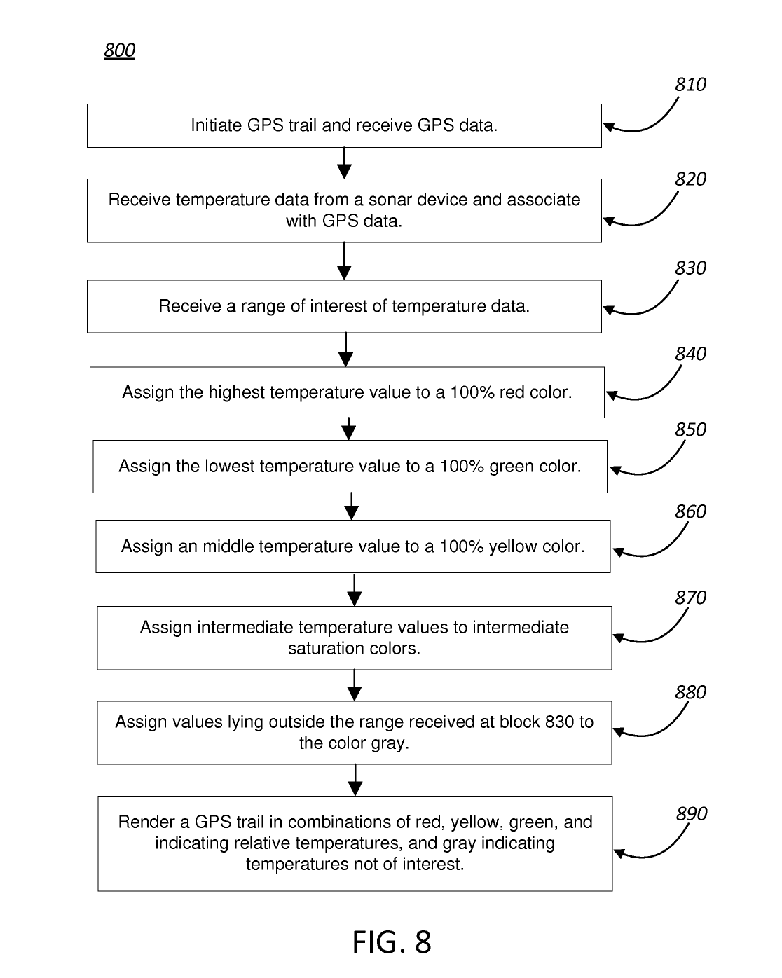

FIG. 8 illustrates a flow diagram of a method 800 for acquiring, processing, and displaying a GPS trail in accordance with various implementations herein. In one implementation, method 800 may be performed by any computing system, including a computing system like that referenced in FIG. 4, a portable computer system, a smart phone device, a remote server, a marine electronics device, a cloud server and the like. It should be understood that while method 800 indicates a particular order of execution of operations, in some implementations, certain portions of the operations might be executed in a different order, and on different systems. Further, in some implementations, additional operations or steps may be added to the method 800. Likewise, some operations or steps may be omitted. In one implementation, method 800 may be performed by one or more computer applications, where the computer applications may implement one or more of the steps described below.

At block 810, a GPS trail may be initiated and GPS data 432 may be received by a computing device 410. The collection of the GPS data 432 may be caused by the execution of instructions from the memory 414 and received by the processor 412. Alternatively, the collection of GPS data 432 may 410 be triggered by a user via the user interface 422 of the computing device 410. In some implementations the initiation of a GPS trail may be an automatic process triggered by the powering on of the computing device 410. The initiation of the GPS trail may alternatively be manually triggered by a user action, such as the selection of a related view or task on the computing device 410.

At block 820, temperature data 462 may be acquired from the temperature gauge 460 via the network interface 418 of the computing device 410. The temperature data 462 may be associated with contemporaneous GPS data 432 based on a clock, time stamps, or any other synching mechanism. The collection of the temperature data 462 may similarly be caused by the execution of instructions from the memory 414 and received by the processor 412. The collection of the sonar data 452 may be triggered by a selection by the user or upon powering on the computing device 410.

At block 830, the computing device processor 412 may receive a user-selected range of interest. This temperature range of interest may have a highest value and a lowest value. The computing device processor 412 may further determine a range of all the temperature data acquired at block 820. This acquired temperature range may have a highest value and a lowest value.

At block 840, if the highest value of the acquired temperature range determined at block 830 lies within the range of interest received at block 830, then the highest value of the acquired temperature range may be assigned to a first color. Otherwise, the highest value of the range of interest may be assigned to the first color. The first assigned color may be red. The assigned color may be predetermined, or may be customized by the user.

At block 850, if the lowest value of the acquired temperature range determined at block 830 lies within the range of interest received at block 830, then the lowest value of the acquired temperature range may be assigned to a second color that is contrasting to the color assigned at block 840. Otherwise, the lowest value of the range of interest may be assigned to the second color. The assigned second color may be green. The second color may be predetermined, or may be customized by the user.

At block 860, a middle value may be determined. This middle value may be the mean of the two values assigned to the first and second colors at blocks 840 and 850, respectively. The middle value may be assigned a third color that is contrasting to both the first and second colors. For instance, the middle value in the range may be assigned to a color of yellow. The third color may be predetermined, or may be customized by a user.

At block 870, intermediate values that are within the range received at block 830, but are not the highest, lowest, or middle values determined at blocks 840, 850, and 860 may be determined. These intermediate values may be assigned colors that are a combination of two colors. For instance, the range of interest received at block 830 may be 80 degrees to 86 degrees. The range of temperatures received, however, may be 82 degrees to 88 degrees. According to block 840, because the highest temperature received is not within the range of interest, the highest value of the range of interest (i.e., 86 degrees) is assigned to the color red. According to block 850, because the lowest temperature received is within the range of interest, the lowest temperature received (i.e., 82 degrees) is assigned to the color green. The middle value (i.e., 84 degrees, the mean or 82 degrees and 86 degrees) is assigned to the color yellow. Values in between 82 degrees and 84 degrees may be assigned to colors that are a combination of the two colors assigned to those values (i.e., green and yellow). For example, the values shown in Table 2 may be used to define colors that are a combination of green and yellow that may assigned to intermediate temperatures

TABLE 2

| | |
|---|---|
| Temperature | Color |

| (degrees F.) | % Green | % Yellow |
|---|---|---|
| 82.0 | 100 | 0 |
| 82.1 | 95 | 5 |
| 82.2 | 90 | 10 |
| 82.3 | 85 | 15 |
| 82.4 | 80 | 20 |
| 82.5 | 75 | 25 |
| 82.6 | 70 | 30 |
| 82.7 | 65 | 35 |
| 82.8 | 60 | 40 |
| 82.9 | 55 | 45 |
| 83.0 | 50 | 50 |
| 83.1 | 45 | 55 |
| 83.2 | 40 | 60 |
| 83.3 | 35 | 65 |
| 83.4 | 30 | 70 |
| 83.5 | 25 | 75 |
| 83.6 | 20 | 80 |
| 83.7 | 15 | 85 |
| 83.8 | 10 | 90 |
| 83.9 | 5 | 95 |
| 84.0 | 0 | 100 |

A similar table may be created to determine colors to represent depths between 84 degrees and 86 degrees. As discussed above, the colors that represent 84 and 86 degrees may be may be yellow and red, respectively, so intermediate values may be represented by corresponding combinations of yellow and red. Table 2 illustrates assigning colors to depth values in increments of 1/10 of a degree, but larger or smaller increments may be used. Further, Table 2 illustrates a linear relationship between the depth and amounts of each color combined, but other mathematical relationships may be used to determine the combination of colors.

At block 880, all temperatures received at block 820 that fall outside the range of interest received at 830 may be assigned a fourth color. The fourth color may be a color without a hue, such as a shade of gray.

At block 890, the computing device processor 412 may render an image of the GPS trail with portions or the trail being the colors determined at blocks 640, 650, 660, 670, and 680. For example, as illustrated in FIG. 3, a GPS trail 305 may be rendered such that certain portions of the trail may be red, yellow, green, or combinations of red and yellow or yellow and green. These portions may highlight areas where temperature data received falls within the range of interest received at block 830. Further, these portions illustrate relative variations of the temperature data received during the session that fall within the range of interest. However, where temperature data received falls outside the range of interest, such as at the portions 310 and 320, the GPS trail 305 may be rendered in a gray hue. This color scheme may allow a user to more easily interpret data of interest and disregard data outside a range of interest.

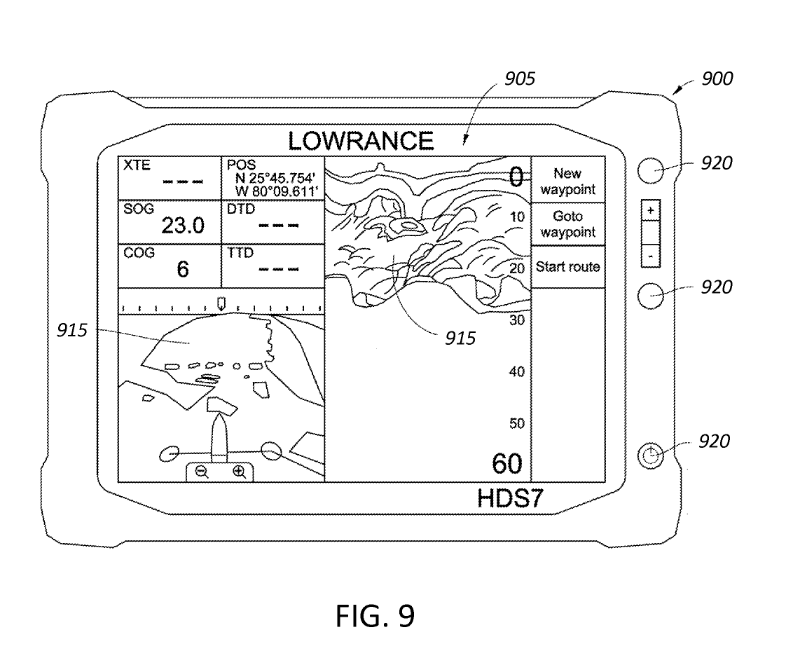

FIG. 9 illustrates a schematic of a marine electronics device 900 in accordance with implementations of various techniques described herein. The marine electronics device 900 includes a screen 905. In certain implementations, the screen 905 may be sensitive to touching by a finger. In other instances, the screen 905 may be sensitive to the body heat from a finger, a stylus, or responsive to a mouse. The marine electronics device 900 may be attached to a National Marine Electronics Association (NMEA) bus or network. The marine electronics device 900 may send or receive data to or from another device attached to the NMEA 2000 bus. For example, in some implementations, the marine electronics device 900 may transmit commands and receive data from a motor or a sensor using an NMEA 2000 bus. The marine electronics device 900 may be capable of steering a vessel and controlling the speed of the vessel, i.e., autopilot. For instance, one or more waypoints may be input to the marine electronics device 900, and the marine electronics device 900 may be configured to steer the vessel to the one or more waypoints. Further, the marine electronics device 900 may be configured to transmit and/or receive NMEA 2000 compliant messages, messages in a proprietary format that do not interfere with NMEA 2000 compliant messages or devices, or messages in any other format. In various other implementations, the marine electronics device 900 may be attached to various other communication buses and/or networks configured to use various other types of protocols that may be accessed via, e.g., NMEA 2000, NMEA 0183, Ethernet, Proprietary wired protocol, etc.

The marine electronics device 900 may be operational with numerous general purpose or special purpose computing system environments and/or configurations. The marine electronics device 900 may include any type of electrical and/or electronics device capable of processing data and information via a computing system. The marine electronics device 900 may include various marine instruments, such that the marine electronics device 900 may use the computing system to display and/or process the one or more types of marine electronics data. The device 900 may display sonar data 452, for example, sonar and sensor data, and images associated with them. The marine electronic data types may include various chart data, radar data, sonar data 452, sensor data including environmental, steering data, dashboard data, navigation data, fishing data, engine data, and the like. The marine electronics device 900 may include one or more buttons 920, which may include physical buttons or virtual buttons, or some combination thereof. The marine electronics device 900 may receive input through a screen 905 sensitive to touch or buttons 920. In some implementations, there may be a button 920 designated to trigger the use of the methods 500, 600, or 800, initiating the start of a session and rendering of a GPS trail. In some implementations, there may be a button 920 designated to toggle between the use of method 600, which may not include a user-defined range of interest, and method 800, which may include a user-define range of interest.

In some implementations, the marine electronics device 900 may be configured to simultaneously display GPS trails associated with one or more types of secondary data. Further, the marine electronics device 900 may also be configured to simultaneously display images and/or data associated with various status indicators. For example, in some implementations, an alarm may be set to trigger when a certain temperature range is encountered by the temperature gauge 460, or when a certain depth is encountered and derived from sonar data 452 received from the sonar device 450. In some instances, in various display modes of operation, the marine electronics device 900 may be configured to simultaneously display images and/or data associated with the marine environmental on the screen 905.

The marine electronics device 900 may be configured as a computing system having a central processing unit (CPU), a system memory, a graphics processing unit (GPU), and a system bus that couples various system components including the system memory to the CPU. In various implementations, the computing system may include one or more CPUs, which may include a microprocessor, a microcontroller, a processor, a programmable integrated circuit, or a combination thereof. The CPU may include an off-the-shelf processor such as a Reduced Instruction Set Computer (RISC), or a Microprocessor without Interlocked Pipeline Stages (MIPS) processor, or a combination thereof. The CPU may also include a proprietary processor.

The GPU may be a microprocessor specifically designed to manipulate and implement computer graphics. The CPU may offload work to the GPU. The GPU may have its own graphics memory, and/or may have access to a portion of the system memory. As with the CPU, the GPU may include one or more processing units, and each processing unit may include one or more cores.

The CPU may provide output data to a GPU. Further, the GPU may generate user interfaces, including graphical user interfaces (GUIs) that provide, present, and/or display the output data. The GPU may also provide objects, such as menus, in the GUI. In some instances, a user may provide input by interacting with objects, and the GPU may receive input from interaction with objects and provide the received input to the CPU. Further, in some instances, a video adapter may be provided to convert graphical data into signals for a monitor, such as, e.g., a multi-function display (MFD 900). The monitor (i.e., MFD 900) includes a screen 905. In various instances, the screen 905 may be sensitive to touch by a human finger, or the screen 905 may be sensitive to body heat from a human finger, a stylus, or responsive to a mouse.

The system bus may be any of several types of bus structures, including a memory bus or memory controller, a peripheral bus, and a local bus using any of a variety of bus architectures. By way of instance, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory may include a read only memory (ROM) and a random access memory (RAM). A basic input/output system (BIOS), containing the basic routines that help transfer information between elements within the computing system, such as during start-up, may be stored in the ROM.

The computing system may further include a hard disk drive interface for reading from and writing to a hard disk, a memory card reader for reading from and writing to a removable memory card, and an optical disk drive for reading from and writing to a removable optical disk, such as a CD ROM or other optical media. The hard disk, the memory card reader, and the optical disk drive may be connected to the system bus by a hard disk drive interface, a memory card reader interface, and an optical drive interface, respectively. The drives and their associated computer-readable media may provide nonvolatile storage of computer-readable instructions, data structures, program modules and other data for the computing system.

Although the computing system is described herein as having a hard disk, a removable memory card and a removable optical disk, it should be appreciated by those skilled in the art that the computing system may also include other types of computer-readable media that may be accessed by a computer. For instance, such computer-readable media may include computer storage media and communication media. Computer storage media may include volatile and non-volatile, and removable and non-removable media implemented in any method or technology for storage of information, such as computer-readable instructions, data structures, program modules, software modules, or other data. Computer-readable storage media may include non-transitory computer-readable storage media. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of instance, and not limitation, communication media may include wired media such as a wired network or direct-wired connection, and wireless media such as acoustic, radio frequency (RF), infrared (IR), and other wireless media. The computing system may include a host adapter that connects to a storage device via a small computer system interface (SCSI) bus, Fiber Channel bus, eSATA bus, or using any other applicable computer bus interface.

The computing system can also be connected to a router to establish a wide area network (WAN) with one or more remote computers. The router may be connected to the system bus via a network interface. The remote computers can also include hard disks that store application programs. In another implementation, the computing system may also connect to the remote computers via local area network (LAN) or the WAN. When using a LAN networking environment, the computing system may be connected to the LAN through the network interface or adapter. The LAN may be implemented via a wired connection or a wireless connection. The LAN may be implemented using Wi-Fi™′ technology, cellular technology, Bluetooth™ technology, satellite technology, or any other implementation known to those skilled in the art. The network interface may also utilize remote access technologies (e.g., Remote Access Service (RAS), Virtual Private Networking (VPN), Secure Socket Layer (SSL), Layer 2 Tunneling (L2T), or any other suitable protocol). In some instances, these remote access technologies may be implemented in connection with the remote computers. It will be appreciated that the network connections shown are exemplary and other means of establishing a communications link between the computer systems may be used.

A number of program modules may be stored on the hard disk, memory card, optical disk, ROM or RAM, including an operating system, one or more application programs, and program data. In certain implementations, the hard disk may store a database system. The database system could include, for instance, recorded points. The application programs may include various mobile applications (“apps”) and other applications configured to perform various methods and techniques described herein. The operating system may be any suitable operating system that may control the operation of a networked personal or server computer.

A user may enter commands and information into the computing system through input devices such as buttons, which may be physical buttons, virtual buttons, or combinations thereof. For example, in some implementations, the system may be configured to have a physical or virtual button dedicated to GPS trail rendering capability of the computing device 410. Other input devices may include a microphone, a mouse, or the like (not shown). These and other input devices may be connected to the CPU through a serial port interface coupled to system bus, but may be connected by other interfaces, such as a parallel port, game port or a universal serial bus (USB).

Certain implementations may be configured for connection to a GPS receiver system and/or a marine electronics device or system. The GPS system and/or marine electronics device or system may be connected via a network interface. For instance, in some implementations, the GPS receiver system may be used to determine position data for the vessel on which the marine electronics device 900 is disposed. Further, the GPS receiver system may transmit position data to the marine electronics device 900. In other implementations, any positioning system known to those skilled in the art may be used to determine and/or provide the position data for the marine electronics device 900.

The marine electronics device 900 may receive external data via a LAN or a WAN. In some implementations, external data may relate to information not available from various marine electronics systems. The external data may be retrieved from the Internet or any other source. The external data may include atmospheric temperature, atmospheric pressure, tidal data, weather, temperature, moon phase, sunrise, sunset, water levels, historic fishing data, and/or various other fishing data.

In one implementation, the marine electronics device 900 may be a multi-function display (MFD) unit, such that the marine electronics device 900 may be capable of displaying and/or processing multiple types of marine electronics data. FIG. 9 illustrates a schematic diagram of an MFD unit in accordance with implementations of various techniques described herein. In particular, the MFD unit may include the computing system, the monitor (MFD 900), the screen 905, and the buttons such that they may be integrated into a single console.

The discussion of the present disclosure is directed to certain specific implementations. It should be understood that the discussion of the present disclosure is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of the implementations and combinations of elements of different implementations within the scope of the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure. Nothing in this application should be considered critical or essential to the claimed subject matter unless explicitly indicated as being “critical” or “essential.”

Reference has been made in detail to various implementations, examples of which are illustrated in the accompanying drawings and figures. In the following detailed description, numerous specific details are set forth to provide a thorough understanding of the present disclosure. However, the present disclosure may be practiced without these specific details. In other instances, well-known methods, procedures, components, circuits and networks have not been described in detail so as not to unnecessarily obscure aspects of the embodiments.

It should also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations and is not intended to limit the present disclosure. As used in the description of the present disclosure and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon a plurality of computer-executable instructions which, when executed by a computer, cause the computer to:
receive a plurality of geographical location data over time;
receive secondary data associated with the geographical location data;
render an image of the plurality of geographical location data as a trail, wherein a graphical attribute of the trail is variable based on variations in the secondary data.

2. The non-transitory computer-readable medium of claim 1, wherein the secondary data is motor status data received from a motor indicating whether the motor is in forward gear, in reverse gear, or out of gear.

3. The non-transitory computer-readable medium of claim 1, wherein the secondary data is temperature data.

4. The non-transitory computer-readable medium of claim 1, wherein the secondary data is depth data.

5. The non-transitory computer-readable medium of claim 1, wherein the secondary data is altitude data.

6. The non-transitory computer-readable medium of claim 1, wherein the secondary data is speed data.

7. The non-transitory computer-readable medium of claim 1, wherein the graphical attribute of the trail is the color of the trail.

8. The non-transitory computer-readable medium of claim 1, wherein the trail is rendered in a first color where the motor status data indicates the motor is in forward gear or in reverse gear, and a second color where the motor status data indicates the motor is out of gear.

9. The non-transitory computer-readable medium of claim 1, wherein the graphical attribute of the trail is the pattern of the trail.

10. The non-transitory computer-readable medium of claim 1, wherein the trail is rendered in a first pattern where the motor status data indicates the motor is in forward gear or in reverse gear, and a second pattern where the motor status data indicates the motor is out of gear.

11. A non-transitory computer-readable medium having stored thereon a plurality of computer-executable instructions which, when executed by a computer, cause the computer to:
receive a plurality of geographical location data over time;
receive secondary data associated with the geographical location data;
determine a range of the secondary data received;
assign the highest value in the range to a first color;
assign the lowest value in the range to a second color, wherein the second color is different from the first color;
render an image of the plurality of geographical location data as a trail wherein the color of the trail is rendered in the first color where the associated secondary data is the highest value in the range, and in the second color where the associated secondary data is the lowest value in the range.

12. The non-transitory computer-readable medium of claim 11, wherein the secondary data is temperature data.

13. The non-transitory computer-readable medium of claim 11, wherein the plurality of computer-executable instructions which, when executed by the computer, further cause the computer to assign an intermediate value in the range to a third color, wherein the third color is different from both the first and second color, and wherein the color of the trail is further rendered in the third color where the associated secondary data is the intermediate value.

14. The non-transitory computer-readable medium of claim 13, wherein the first color is red, the second color is green, and the third color is yellow.

15. The non-transitory computer-readable medium of claim 11, wherein the range is user-defined and wherein the trail where the associated secondary data is outside the range is rendered in a fourth color that is different from the first color, the second color, and the third color.

16. The non-transitory computer-readable medium of claim 11, wherein the first color is red, the second color is green, the third color is yellow, and the fourth color is gray.

17. The non-transitory computer-readable medium of claim 11, wherein the secondary data is depth data derived from sonar data, speed data, or altitude data derived from GPS data.

18. A method of displaying geographical location data and associated secondary data on a screen, comprising:
receiving a plurality of geographical location data over time;
receiving secondary data associated with the geographical location data;
determining a range of the secondary data;
assigning the highest value in the range to a first color;
assigning the lowest value in the range to a second color, wherein the second color is different from the first color;
rendering an image of the plurality of geographical location data as a trail wherein the color of the trail is rendered in the first color where the associated secondary data is the highest value in the range, and in the second color where the associated secondary data is the lowest value in the range.

19. The method of claim 18, further comprising assigning an intermediate value in the range to a third color, wherein the third color is different from both the first color and second color, and wherein the color of the trail is further rendered in the third color where the associated secondary data equals the intermediate value.

20. The method of claim 18, wherein the first color is red, the second color is green, and the third color is yellow.
